(19) United States
(12) Patent Application Publication
(10) Pub. No.: US 2007/0055775 A1
(43) Pub. Date: Mar. 8, 2007

(54) Method and system for controlling information access from a website via Web or WAP access

(76) Inventor: Mei Kwang Kevin Chia, Singapore (SG)

Correspondence Address: LAWRENCE Y.D. HO & ASSOCIATES PTE LTD, 30 BIDEFORD ROAD, #07-01, THONGSIA BUILDING, SINGAPORE, 229922, SG

(21) Appl. No.: 11/218,558

(22) Filed: Sep. 6, 2005

(51) Int. Cl. G06F 15/173

(52) U.S. Cl. 709/225

(57) ABSTRACT

The present invention provides a computer method and system for controlling information access of information from a personal or enterprise website, via web or wap access. The client system or a viewer might have an identifier that identifies him as subscriber, or alternatively the client may be grouped as default public group. When a subscriber or client requests for a certain page in the website, the server will map the identifier or Access ID of the viewer or subscriber, and further determine the Access Control Group the subscriber belongs to. Based on the Access Control Group and origin of access (e.g. web or Wap), the website information or content may then be rendered and displayed accordingly.

### TECHNICAL FIELD

The covered invention relates to a computer method and system for controlling access to personal WAP and Web (HTTP) pages over the internet.

### BACKGROUND OF THE INVENTION

The Internet or “the Net” is a worldwide system of computer networks—a network of networks in which users at any one computer may, if they have the rights, view or get information from any other computer.

Today, the Internet is a public, cooperative, and self-sustaining facility accessible to hundreds of millions of people worldwide. Physically, the Internet uses a portion of the total resources of the currently existing public telecommunication networks. Technically, what distinguishes the Internet is that it uses a set of protocols called Transmission Control Protocol/Internet Protocol (TCP/IP).

Using TCP/IP, the interconnected computers exchange information using various services such as electronic email, Internet Relay Chat and the World Wide Web (“WWW”). WWW service enables transfer of graphical web pages to remote client machines from server identifiable via a Uniform Resource Locator (URL). To view a specific page, client machines will provide a specific URL request in a browser and be able to view or get information. The browser may be a client application program that provides an interface to view and interact with the millions of pages of information on the WWW. The most common type of URL request being used is Hypertext Transfer Protocol (“HTTP”).

HTTP runs on top of the TCP/IP suite of protocols and comprise of a set of rules for transferring files such as text, graphic images, sound, video and other multimedia files on the WWW. HTTP concepts brought forward ideas that files may contain references to other files. By way of multiple transfer requests, users may practically navigate through vast amounts of interlinked pages. Web pages are typically defined using Hypertext Markup Language (“HTML”) which provides standard set of tags that define how the browser shall display the content.

Wireless and mobility have been keywords for recent technological innovations. Hence, the popularity of wireless internet. This gives users the ability to leverage on the ubiquity of mobile devices to access information, which is what fixed internet is already providing. Subsequently mobile or wireless service providers moved on to tap on the vast amount of information of the WWW via Wireless Access Protocol (“WAP”). The concept of availability of information “Anywhere-Anytime” is fast becoming a reality.

WAP is a specification for a set of communication protocols to standardize the way that wireless devices such as cellular phones, PDA or other WAP-enabled devices use internet services, WWW being one of the most popular service. The standardization is required as different manufacturer of devices used different technologies and potentially caused interoperability issues. WAP is also intended to overcome the HTML definition language which was originally meant for fixed internet. HTML is written in such a way that require fast connections, fast processors, big screens, large memories, efficient input device and even proper audio output. These characteristics are a big challenge for mobile devices which have substantially lower specifications and lower bandwidth that hinders the operational use of HTML.

WAP defines a completely new markup language called Wireless Markup Language (WML), with scripting language called WMLScript and bitmap format called Wireless Bitmap (“WBMP”). In short, WML provides a simpler but much more strictly defined structure than HTML. WAP also defines new protocol stack which has thin request and reduced protocol overhead. Due to many enhancements introduced here and for easier implementation, a WAP Gateway is established between the phones or mobile devices and servers providing the content. This concept of use of WAP gateway is shown in FIG. 1. On top of protocol translations, WAP gateway will also compresses the WML into a more compact form; saving over-the-air bandwidth reduced mobile device processing requirements. Having the technologies in place, there are many mobile applications that has brought fixed internet environment to the agile mobile market, such as m-commerce (m stands for mobile), email, Instant Messaging, moblog (for mobile blog), friendster and so on.

Currently, when websites are published, all the information on website is made available via the internet. Anyone visiting the website is able to view all the information. However, not all information may be suitable or was intended for free disclosure. An example of such unintended information may be personal particulars of the owner of the website.

It can thus be seen that there exists a need for a simple and low cost method for controlling information access from a website via web or wap access.

### SUMMARY OF INVENTION

The present invention provides a computer method and system for controlling information access from a personal or enterprise website, via web or wap access. The client system or a viewer might have an identifier identifying him as subscriber. Alternatively, the client may further be categorized as a default public group. When the subscriber requests for a certain page in the website, a server of the system will map the Access ID of the viewer or subscriber, and then determine an Access Control Group the subscriber belongs to. Base on the Access Control Group and origin of access, the webpage information or content will then be rendered and displayed accordingly.

Accordingly, in one aspect, the present embodiment provides, a system for controlling information access from an owner's website via Web or WAP access, the system comprising: a client portion having at least one means for a viewer to access the owner's website; a network means comprising means for providing internet connectivity to the owner's website; a server for hosting the owner's website, the server comprising: an Access ID database for storing Access IDs for subscribers; a Storage Database for storing content and data for websites; an Access Control Information Database for storing Access Control Groups assigned to the subscribers and Access Control Groups associated with the content and data; a Layout Template Database for storing Layout templates; and a Rendering Engine Server for rendering Web or WAP pages; wherein the subscriber or the viewer is allowed controlled access to the content and data on the owner's website depending on the Access Control Group assigned to the subscriber or the viewer.

Accordingly, in another aspect, the present embodiment provides, a method for controlling information access from an owner's website via Web or WAP access by a viewer or a subscriber, said method comprising the steps: checking the viewer for an Access ID; retrieving said Access ID is available; determining whether said viewer is a subscriber; mapping said Access ID to subscriber information; selecting an Access Control Group according to said subscriber information; determining whether said Access Control Group is inclusive; rendering of content of said owner's website according to a layout template assigned to said content; displaying rendered pages to said viewer or said subscriber; and allowing said viewer or said subscriber to view rendered pages and perform relevant actions in said rendered pages; wherein said relevant action are controlled by said Access Control Group of said viewer or said subscriber.

### BRIEF DESCRIPTION OF THE DRAWINGS

FIG. 1 illustrates a typical network flow of WAP for mobile internet;

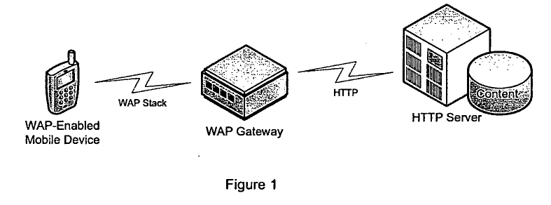

FIG. 2 illustrates an overview of the concept of use of the present invention;

FIG. 3 is a system diagram illustrating an embodiment of the present invention; and

FIG. 4 is a flow chart illustrating a method in accordance with an embodiment of the present invention.

### DETAILED DESCRIPTION OF THE INVENTION

The present invention proposes a system and method for controlling information access from a website via both fixed internet and mobile internet access. Using an Access Control List, a website owner can group viewers (persons who access his website either from web or wap) or subscribers into different categories and selectively display information to the viewer or subscriber based on the category of the viewer or subscriber. Such a category is referred to as the Access Control Group.

Currently there is a proposed standard called Open Profiling Standard (“OPS”) suggesting how Web users can control the personal information they share with Web sites. OPS has a dual purpose: (1) to allow Web sites to personalize their pages for the individual user and (2) to allow users to control how much personal information they want to share with a Web site. OPS mechanism is implemented using Platform for Privacy Preference (“P3P”) protocol. The main difference here is OPS aim towards visitor with commercial-website relationship while the invention covers also personal-website and various personal relationships with the visitors. Since personal-websites or often referred to as web profiles may also contain sensitive information, the owner would likely want to explicitly control the exposure of such information. For enterprise websites, the control will be more towards serving the appropriate audience and subscribers.

In the present invention, every piece of content and data that may be input into a website for display, regardless of format (text, rich text, image, audio and other multimedia), the website owner may further explicitly specify a category or an Access Control Group in which the content and data is associated with.

There will be a set of predefined Access Control Groups for owners to categorize their pages for their subscribers to have access to. On top of default Access Control Groups, owners may further define additional Access Control Groups with their own parameters. Access Control Groups may be inclusive or exclusive. Exclusive Access Control Groups refer to categories that do not include other groups while inclusive has the opposite effect. An Inclusive type group means that it is a group that contains many other sub groups while exclusive type is merely a group by itself.

Several of these Access Control Groups in turn form an Access Control List. The Access Control List may of several versions, each having different effective dates. This thus allows the owner to have one Access Control List active at any one time, while other versions may be prepared based on new information and subscription.

When a subscriber accesses the website having Access Control in accordance with the present invention, upon identifying the subscriber's Access Control Group, information shall be retrieved according to the Access Control Group pre-assigned to the subscriber. The actions available to each Access Control Group for a particular piece of information may be viewing, referencing, adding, updating, deleting information or combination of the above.

Next, the retrieved information is rendered into viewable pages accordingly to the format of access, either web or wap. For web, the page result shall be in form of HTML pages while for wap, it will be in WML pages.

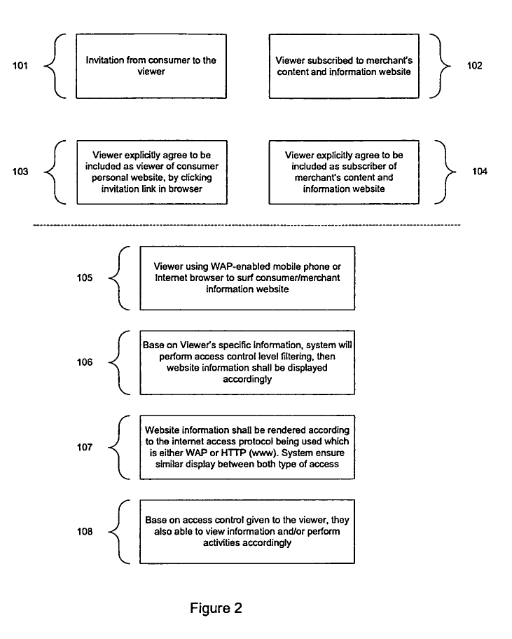

Referring to FIG. 2, with regard to an overview of the present invention, the flow of activities may start from the owner inviting a viewer to be a subscriber or friend in order to have access to the website's information. For owners of personal or consumer websites, it starts with section 101 consumer and for enterprise owner or merchants, it starts with 102. The invitation may be in form of a friendship linkage, newsletter invitation and so on. Next, in Section 103 and 104, a response from the viewer explicitly acknowledging becoming a subscriber to the information provided by the owner is received. The response can be in form of email, Short Message Service (SMS) or web page link in the browser. Especially for enterprise subscribers, this is an opt-in action to gain explicit agreement from the subscriber.

Upon confirmation from the viewer, the viewer is now considered a subscriber and the subscription is considered valid or active. At this stage, the owner may assign the subscriber to one or more of several different Access Control Groups. Each of the Access Control Groups allow different levels of access to content and data on the consumer/merchant information website.

In section 205, the subscriber after acknowledging explicit agreement to be a subscriber may use a browser comprising either fixed internet or mobile internet to surf the consumer/merchant information website. There are various ways to access the website such as direct URL, WAP gateway redirection or using search algorithm provided by the system. The subscriber may be identified by an identifier such as an Access ID. In WAP environment, the Access ID may be the Mobile Station International ISDN Number (“MSISDN”) which is the mobile phone number used to access the wap page.

For web access, the subscriber will need to login to the system to be properly identified. The Access ID may be as simple as a Username which needs to be accompanied by a password login process. In this scenario, the subscriber will have to be registered with the same service provider or the web community as well.

Upon verification of the subscriber, a check is performed in the Access Control List to determine the Access Control Group, as outlined in section 106. The Access Control Group of the subscriber is checked by cross referencing the subscriber's identifier or Access ID. After checking the Access Control List, the pages requested shall be rendered according to the Access Control Group of the subscriber, and whether by the request was initiated via WAP or web access. This will ensure similar display between both types of access, as in section 107. Finally access control is then given to the subscriber based on the Access Control Group which also governs the type of action which may be performed by the subscriber, as in section 108.

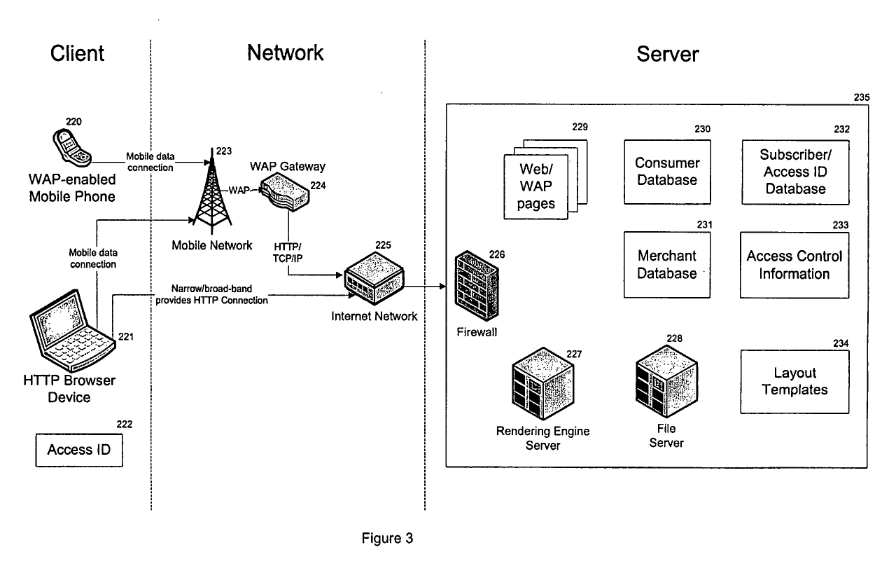

Referring to FIG. 3, the system in accordance with the present embodiment comprises at least a client portion, at least a Network portion and at least a Server 235. The Client portion may comprise of at least one WAP-enabled mobile phone 220 or at least one HTTP browser enabled device 221 such as a Laptop computer having a mobile internet connection. The Access ID 222 of the subscriber using the client portion to access the websites would be required.

WAP-enabled mobile phones 220 may connect to the internet via WAP Gateway 224 using General Packet Radio Services (“GPRS”) or High-Speed Circuit-Switch Data (“HSCSD”) connections. While other HTTP browser enabled devices 221 may also use narrow/broadband http HTTP type of connection.

The server portion 235 comprises a firewall 226 which is used to control and prevent internal system resources from unauthorized access from outside the server 235. A Consumer Database 230 and a Merchant Database 231 is used for storing content belonging to owners of websites depending on whether they are Personal websites or Enterprise websites. The content stored may be in text, rich text, images, audio, video or any other type of multimedia information.

The server 235 further comprises a rendering engine server 227 which is responsible for rendering or processing content in the Consumer database 230 and the merchant database 231 into a viewable pages in either web or wap pages 229.

The rendering process in the rendering engine server 227 takes relevant filtered content and merges it with layout templates stored in a Layout Template Database 234 that may have been assigned for certain relevant pages.

All subscribers' information, including their Access IDs 222 are stored in subscriber/Access ID database 232. In addition, the Access Control Groups and Access Control Lists are stored in an Access Control Information database 233.

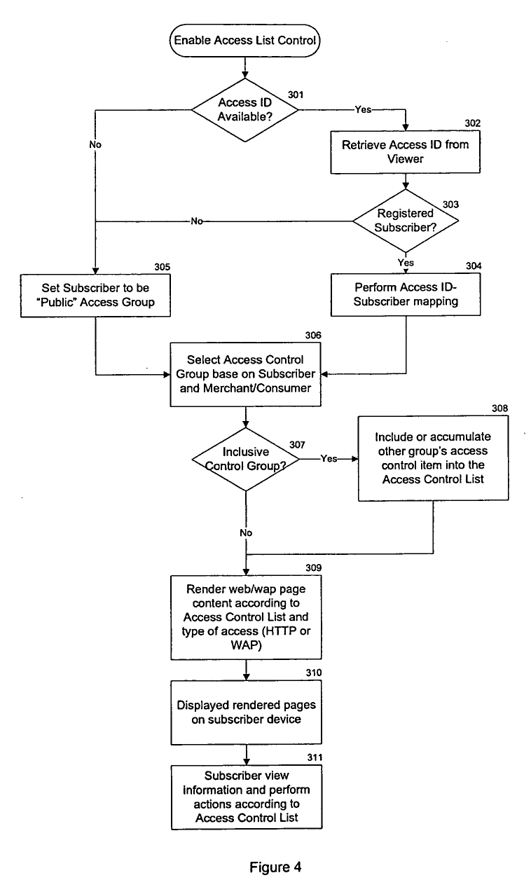

Referring to FIG. 4, the method in accordance with the present embodiment when a viewer requests content or information from an owner's website starts with the step of checking 301 for the Access ID 222 of a viewer attempting to access the system.

If Access ID 222 is available, the system will retrieve 302 the Access ID 222 from the viewer. Next the step of determining 303 whether the viewer is a registered subscriber. The Access ID 222 retrieved is compared with the Subscriber/Access ID Database 232. Following which, the step of mapping the Access ID 222 to the subscriber is performed.

However, if Access ID 222 is not available or not retrievable, then the viewer by default will be classified 305 as a subscriber belonging to “Public” Access Control Group.

Next, after identifying the subscriber, the relevant Access Control Group for shall be selected 306 according to information stored in the Consumer Database 230 or Merchant Database 231. In the next step, the system performs an internal check 307 to determine whether the Access Control Group is of the inclusive type.

An Inclusive type group means that it is a group that contains other groups while exclusive type is merely a group by itself. Hence for an inclusive group, all other relevant Access Control Groups shall be accumulated into the Access Control List, as depicted in step 308.

Next, the rendering engine server 227 will perform a rendering 309 of the content by using the Layout Template 234 assigned to the page. The rendering will be also be based on format of layout, either HTML page(s) for web access or WML page(s) for WAP access. The intention of having the rendering engine server 227 is to ensure similarity of displays between different formats, in devices used by subscribers. Upon completing of the rendering step 309, the rendered pages are sent to the subscriber's device for display.

The subscriber may then view the content and perform relevant actions allowed by the system base on the Access Control Group in the Access Control List.

The present invention thus provides a computer method and system for controlling information access from a web or WAP site by a client system or the subscriber. The owner of the web or WAP site will determine an Access Control List that governs information access activities based on the subscriber's Access Control Group.

It will be appreciated that various modifications and improvements can be made by a person skilled in the art without departing from the scope of the present invention.

1. A system for controlling information access from an owner's website via Web or WAP access, said system comprising:
a client portion having at least one means for a viewer to access said owner's website;
a network means comprising means for providing internet connectivity to said owner's website;
a server for hosting said owner's website,
said server comprising: an Access ID database for storing Access IDs for subscribers; a Storage Database for storing content and data for websites; an Access Control Information Database for storing Access Control Groups assigned to said subscribers and Access Control Groups associated with said content and data; a Layout Template Database for storing Layout templates; and a Rendering Engine Server for rendering Web or WAP pages;
wherein said subscriber or said viewer is allowed controlled access to said content and data on said owner's website depending on said Access Control Group assigned to said subscriber or said viewer.

2. The system according to claim 1, wherein said Storage Database for further comprise a Consumer Database for storing content and data for personal websites and a Merchant Database for storing content and data for enterprise websites.

3. The system according to claim 1, wherein said at least one means for a viewer to access said owner's website may further comprise one of said following: WAP enabled mobile phone or http browser enabled device.

4. The system according to claim 1, further comprising a firewall for controlling and preventing unauthorized access of internal system resources.

5. The system according to claim 1, wherein said Web or WAP pages are rendered according to said content and data and layout templates associated with said content and data thus ensuring similarity of displays between different formats.

6. The system according to claim 1, wherein said controlled access may comprise one or more of said following: viewing, referencing, adding, updating, or deleting.

7. The system according to claim 1, wherein said subscriber further having an identifier or an Access ID.

8. The system according to claim 7, wherein said identifier may be a Mobile Station International ISDN number.

9. The system according to claim 1, wherein said Access Control Group is pre-assigned to said subscriber by said website owner.

10. The system according to claim 1, wherein a plurality of Access Control Groups forms an Access Control List.

11. A method for controlling information access from an owner's website via Web or WAP access by a viewer or a subscriber, said method comprising the steps:
a) checking said viewer for an Access ID;
b) retrieving said Access ID is available;
c) determining whether said viewer is a subscriber;
d) mapping said Access ID to subscriber information;
e) selecting an Access Control Group according to said subscriber information;
f) determining whether said Access Control Group is inclusive;
g) rendering of content of said owner's website according to a layout template assigned to said content;
h) displaying rendered pages to said viewer or said subscriber; and
i) allowing said viewer or said subscriber to view rendered pages and perform relevant actions in said rendered pages;
wherein said relevant action are controlled by said Access Control Group of said viewer or said subscriber.

12. The method according to claim 11, further comprising a step c1): assigning said viewer with a default Access Control Group if Access ID is not available.

13. The method according to claim 11, wherein in step f), an inclusive Access Control Group further comprises other relavant Access Control Groups that may be accumulated into an Access Control List.

14. The method according to claim 11, wherein step g) further comprises rendering Web or WAP pages according to said content and said layout templates associated with said content thus ensuring similarity of displays between different formats.

15. The method according to claim 11, wherein in step i), said relevant actions may comprise one or more of said following: viewing, referencing, adding, updating, or deleting.

16. The method according to claim 11, wherein said Access Control Group is pre-assigned to said subscriber by said website owner.

17. The method according to claim 11, wherein a plurality of Access Control Groups forms an Access Control List.

18. The method according to claim 17, wherein said Access Control List may have several versions with different effective dates.

19. The method according to claim 11, further comprising steps before step a), the steps comprising:
i) inviting said viewer to become a subscriber;
ii) receiving explicit response from said viewer agreeing to said invitation; and
iii) assigning said subscriber with at least one Access Control Group.
